(19) United States
(12) Patent Application Publication
(10) Pub. No.: US 2008/0039141 A1
(43) Pub. Date: Feb. 14, 2008

(54) Changing the scrambling code of a base station for wireless telecommunications

(76) Inventors: Holger Claussen, Swindon (GB); Louis Gwyn Samuel, Swindon (GB)

Correspondence Address: Lucent Technologies Inc., Docket Administrator - Room 3J-219, 101 Crawfords Corner Road, Holmdel, NJ, 07733-3030, US

(21) Appl. No.: 11/502,643

(22) Filed: Aug. 10, 2006

(51) Int. Cl. H04B 1/38; H04M 1/00

(52) U.S. Cl. 455/561

(57) ABSTRACT

A method is provided of a base station for wireless telecommunications changing scrambling code to be applied to pilot signals for transmission. The method comprises automatically:
identifying a need to change scrambling code,
selecting a new scrambling code for use,
reprogramming the base station to use the scrambling code, and
using the new scrambling code for subsequent pilot signal transmissions.

### FIELD OF THE INVENTION

The present invention relates to telecommunications, in particular to wireless telecommunications.

### DESCRIPTION OF THE RELATED ART

There are wireless telecommunications systems based on code division multiple access, such as those compliant with the Universal Mobile Telecommunications System (UMTS) standard. Particularly in such systems, neighbouring base stations apply distinctive scrambling codes to some of their messages to mobile terminals. A mobile terminal is informed of the range of possible scrambling codes to expect, and then identifies a base station using one of those scrambling codes as being the one from which the mobile terminal is to receive and decode signals.

To minimise interference of one base station with another, and prevent identification problems, the scrambling code used by a base station should be different from that of neighbouring base stations, including any base stations with which there might be coverage area overlap. However, this does not always occur. This is particularly so in networks that lack centralised planning, such as so called self-configuring or self-deploying networks. Therefore assignment of replacement scrambling codes can become necessary. This is especially likely in networks that significantly change their configurations over relatively short timescales, such as self-configuring networks in military or emergency scenarios. In such scenarios, assignment of another scrambling code can be required frequently.

Currently, the assignment of a scrambling code is done by a human operator disabling the base station, manually updating the scrambling code to be used, then rebooting the base station. Unfortunately, this procedure causes a period of lost coverage and dropped calls.

### SUMMARY OF THE INVENTION

The inventors found a way to the change the scrambling code used by a base station without requiring a human operator to effect that change.

An example of the present invention is a method of a base station for wireless telecommunications changing the scrambling code which is used by being applied to pilot signals for transmission. The method comprises automatically:

identifying a need to change scrambling code,

selecting a new scrambling code,

reprogramming the base station with the scrambling code, and

applying the new scrambling code to pilot signals for transmission.

### BRIEF DESCRIPTION OF THE DRAWINGS

Embodiments of the present invention will now be described by way of example and with reference to the drawings, in which:

FIG. 1 is a diagram illustrating a wireless telecommunications network according to a first embodiment of the present invention,

FIG. 2 is a diagram illustrating self-deployment of the network shown in FIG. 1 as representations of the network at a sequence of three points in time denoted (a), (b) and (c),

FIG. 3 is a diagram showing one of the base stations shown in FIG. 1,

FIG. 4 is a flow chart illustrating processes relating to scrambling code assignment undertaken in the network shown in FIG. 1,

FIG. 5 is a diagram illustrating a method of performing scrambling code assignment undertaken in the network shown in FIG. 1

FIGS. 6 and 7 are diagrams illustrating a method of scrambling code assignment in a network according to a second embodiment of the invention, and

FIG. 8 is a flow chart illustrating a method of scrambling code assignment in a network according to a third embodiment of the invention.

### DETAILED DESCRIPTION

When considering a known system, the inventors realised that it should be possible to identify a need for a change in scrambling code, then select a new scrambling code and implement its use, in an automated procedure without requiring a human operator to effect the scrambling code change.

A first example will now be described in detail.

### The Network

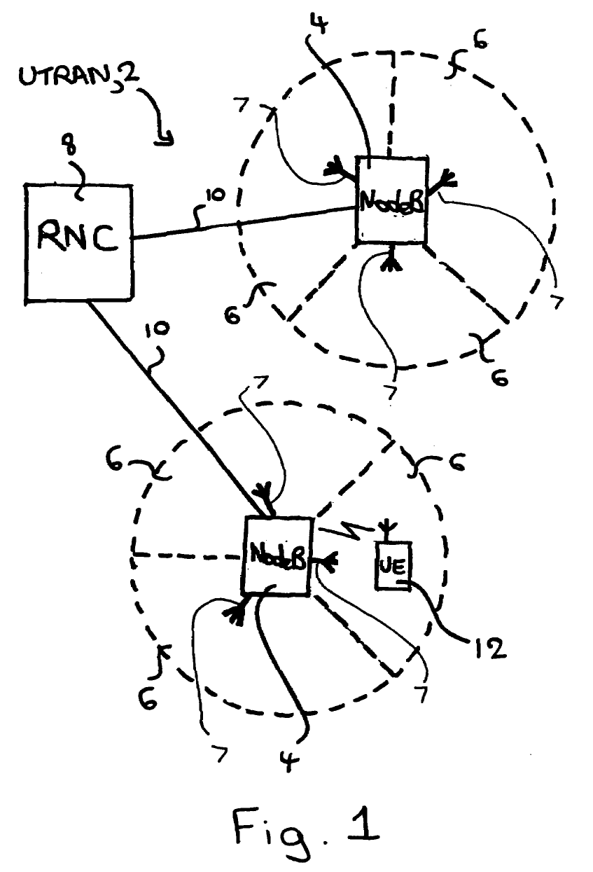

An example network is a Universal Mobile Telecommunications System (UMTS) terrestrial access network (UTRAN), which is a type of wideband code division multiple access (CDMA) network for mobile telecommunications. The UTRAN network is basically as shown in FIG. 1. Only one radio network controller and two base stations of the UTRAN network 2 are shown for simplicity. As shown in this Figure, the UTRAN network 2 includes base stations 4. In the Figure, each of the base stations 4 is also designated “Node B” in accordance with UMTS terminology. A cell, also referred to as a sector, is the radio-coverage area served by a corresponding antenna of a base station. Each base station typically has three cells 6, each covered by one of three directional antennas 7 angled at 120 degrees to each other in azimuth. Each radio network controller (RNC) 8 typically controls several base stations 4 and hence a number of cells 6. A base station 4 is connected to its controlling radio network controller (RNC) 8 via a respective interface 10 known as an lub interface. In use, a mobile user terminal 12 (often referred to as User Equipment (UE) in UMTS terminology) communicates with a serving radio network controller (RNC) 8 via at least one cell 6 of at least one base station 4. In that way, the mobile user terminal communicates with the UTRAN network 2.

### The Network is a Self-Deploying Network

The network 2 is a self-deploying network. A self-deploying network is one that learns about its current performance, for example in terms of its radio coverage and traffic capacity, and in consequence decides on changes in base station position, and also changes in transmission power level, such as of pilot signals, and then implements such changes without human intervention.

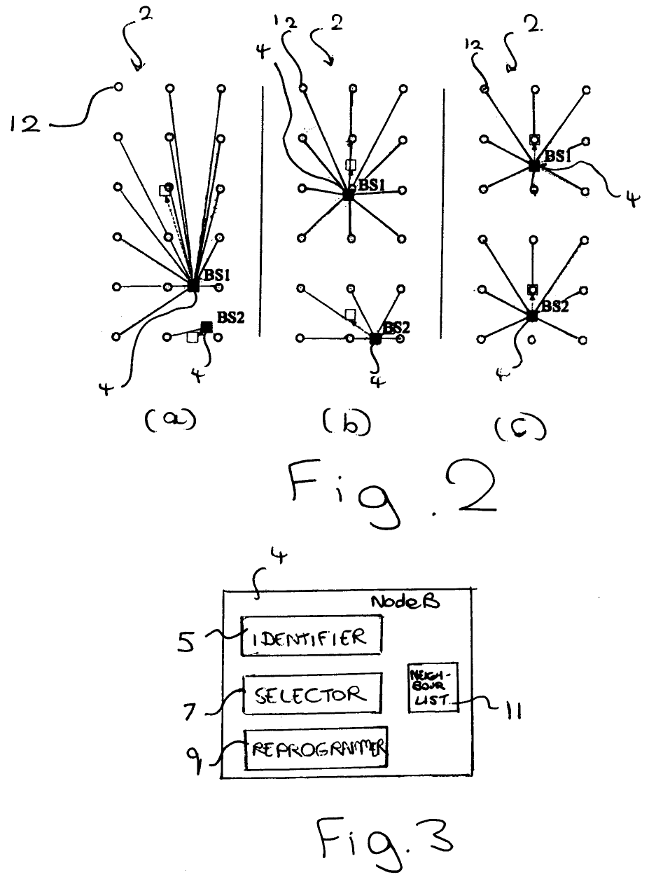

An example of the self-deployment process is shown in FIG. 2. Self-deployment is also known as self-organising, self configuration, auto-configuration and the like. As shown in FIG. 2, in the network 2, two base stations 4 are shown as solid squares denoted BS1 and BS2 respectively. FIG. 2 consists of three parts, denoted (a), (b) and (c). These three parts show the same network 2 but at different time steps, first (a) then (b) then (c). The user terminals are represented in this FIG. 2 as circles; for simplicity of illustration only one of the user terminals is indicated by reference symbol 12.

Initially, the user terminals 12 are connected to the base station that provides a pilot signal received with the strongest power. At each time step (a), (b) and (c), the optimal positions of the base stations are calculated based on the distribution of current connections to mobile terminals. These optimal positions are shown in FIG. 2 as outline squares. The base stations then move towards their respective optimal positions as calculated in that time step so as to be positioned there for the next time step.

The optimal position of a base station at any time depends on a variety of factors, such as best use of radio resources, costs, practical limits on suitable locations, legislation and public policy. As regards radio resources, transmission power and available frequency spectrum are important factors within a constraint as to maximum permissible transmission power.

### Scrambling Codes

In the UMTS network 2, each base station is associated with a scrambling code, sometimes referred to as a primary scrambling code. Accordingly, the scrambling code acts as a base station identifier. Each scrambling code is a complex sequence of 38400 chips, where a chip is a 1/r part of a spread symbol spread with a spreading code of length r. Each base station sends a standard pilot signal scrambled using its own scrambling code every 10 milliseconds, that being the duration of a UMTS frame. Such scrambled plot signals are sent on the Common Pilot Channel, CPICH.

A mobile terminal receives such a scrambled pilot signal and deduces, by symbol-by-symbol correlation with possible codes, which scrambling code was used so as to identify the base station from which the signal was sent. In UMTS networks, a total of 512 scrambling codes are defined.

### Scrambling Code Monitoring and Assignment Process

To minimise interference of one base station on another, the scrambling code used by a base station should be unique within the coverage area of the base station including areas that overlap with the coverage areas of other base stations. However, this does not always occur. Therefore a need to assign another scrambling code can arise.

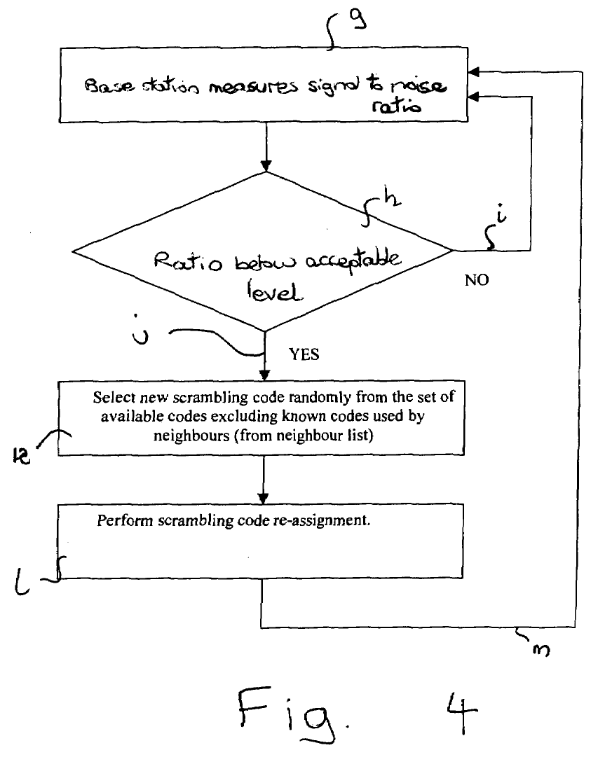

The scrambling code monitoring and assignment process used in the UMTS network consists of three main stages: identification of a need to change scrambling code, selection of a new scrambling code, and performing scrambling code change. These are considered in turn below. Correspondingly, as shown in FIG. 3, base station 4 includes a processor 5 which operates to identify a need to change scrambling code, a selector 7 of another scrambling code, and a further processor 9 operative to reprogram the base station 4 to use the new scrambling code.

### Identification of a Need to Change Scrambling Code

In this example system, base stations hold neighbour lists 11, that is, lists of the identities of neighbouring base stations and their currently associated scrambling codes. However, these neighbour lists cannot be assumed to be complete and reliable.

A pilot signal of an interfering base station that has been scrambled using the same scrambling code as a first base station, would merely appear as an echo of the first base station's own scrambled pilot signal. Also mobile terminals cannot distinguish between base stations that use the same scrambling code. However, a readily identifiable impact of more than one base station using the same scrambling code in an area of overlapping coverage is an increased amount of interference experienced by those base stations. In the network 2, it is an increase in interference that is used to identify a need to assign replacement scrambling codes.

As shown in FIG. 4, a base station 4 measures signal to interference ratio of signals that it receives, i.e. in the uplink direction. The decoding process on the uplink received signal acts to separate signal from interference, enabling this ratio to be determined. In addition, as regards the downlink direction, the base station receives a measurement report from a mobile terminal 12 indicating the signal to interference ratio that the mobile terminal determined in the downlink direction, i.e. to the mobile terminal. This is shown in FIG. 4 as step g.

In an alternative embodiment (not shown), the radio network controller 8 can collate received signal data so as to calculate signal to interference ratio for each base station that it controls.

As a next step, a determination is made, (step h) as to whether or not the signal to interference ratio, either uplink or downlink, falls below an acceptable level. The level at which the ratio becomes considered as unacceptable being, for example, when the ratio goes below, say, 50% of its normal value. If the ratio is acceptable, a return (step i) to a fresh measurement of signal to interference ratio is made. Otherwise, assignment of another scrambling code for the base station is required (step j).

### Selection of a New Scrambling Code

In this example network 2, additional information, known as neighbour lists, identifying neighbouring base stations and their currently used scrambling codes are stored in each base station 4. The base station requiring a new scrambling code excludes from the normal full set of 512 available codes those codes that are known to be used by neighbouring base stations, then selects randomly from among the codes that remain (step k).

### Performing Scrambling Code Change

The base station then applies the selected replacement scrambling code (step l) as explained more fully below.

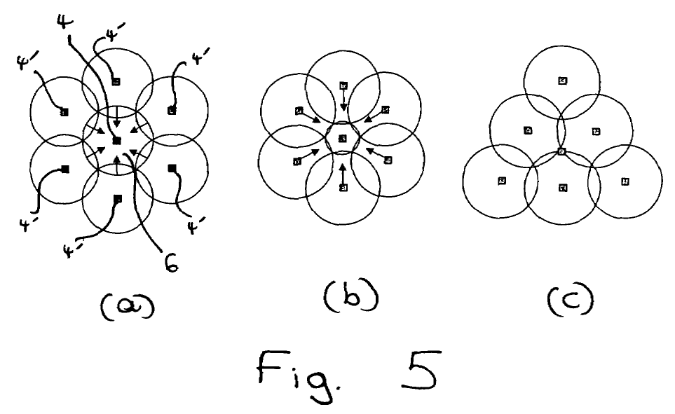

As shown in FIG. 5, the base station for which the new scrambling code is selected gradually reduces the power at which it transmits pilot signals. This is so as to gradually reduce its cell size (i.e. radio coverage area) to zero whilst allowing time for connections with mobile terminals to be handed over to neighbouring cells.

FIG. 5 shows the base station 4 and its neighbouring base stations 4′ at a sequence of three points in time. In FIG. 5(a), the cell size 6 of the base station 4 is reduced causing connections to mobile terminals (not shown in FIG. 5) to transfer to neighbouring base stations 4′. As shown in FIG. 5 (b), because each neighbouring base station optimises its position to serve the mobiles currently connected to itself, each of the neighbouring base stations tend to move in the direction of the newly handed over mobile terminals that it has just taken on. As shown in FIG. 5(c), a time is reached when the cell size of the base station 4 is reduced to zero.

The base station is then reprogrammed to use the new scrambling code and rebooted with the new scrambling code being used thereafter. The power of the pilot signals from the base station is then increased until the cell size becomes as before the scrambling code change operation.

An identifier of the new scrambling code is then transmitted to neighbouring base stations, so that they can each update their own neighbour lists, so as to have available the information that that scrambling code is currently used by one of its own neighbours.

After the change of scrambling code, the base station performs further measurements (note return step m in FIG. 4) of signal to interference ratio to evaluate the effect of the scrambling code change. For example, if there is no improvement in signal to interference ratio, this could mean either that the new scrambling code was already in use by one of the neighbouring base stations, so there is a conflict, or that the interference is not due to scrambling code conflict. If repeated scrambling code changes fail to improve the signal to interference ratio, then the processor in the base station concludes that the interference is most likely not due to conflict between scrambling codes. In that case, the threshold at which signal to interference ratio is to be considered unacceptable by the processor in the base station is made less stringent.

### Various Options

To identify a need to change scrambling code, another parameter that can be measured in place of signal to interference ratio is number of false handovers from a base station per unit time. A false handover is where a mobile terminal attempts to connect to a base station which it identifies, based on scrambling code, as being the correct base station but fails in that connection as the mobile terminal lacks the necessary authentication key-codes because it is not, in fact, the correct base station.

Some systems have base stations that hold complete and reliable neighbour lists. Then, a base station can select a scrambling code that does not conflict with others simply by searching its neighbour list to exclude scrambling codes that there is use by its neighbours. If any neighbour is found using the same scrambling code, then the base station selects a new scrambling code and performs a scrambling code change operation so as to use the new scrambling code.

In some systems, where a relatively large number of scrambling codes are usable, a new code can be selected randomly from the whole group of codes without consideration of which might be already in use. The selected code is then changed to. If an improvement in base station performance results, for example in terms of signal to interference ratio, then use of the selected code is continued. Alternatively, if insufficient improvement is noted, a further scrambling code is randomly selected, from among the complete set, and tried. This approach is possible in some UMTS systems because UMTS systems have up to 512 different scrambling codes available.

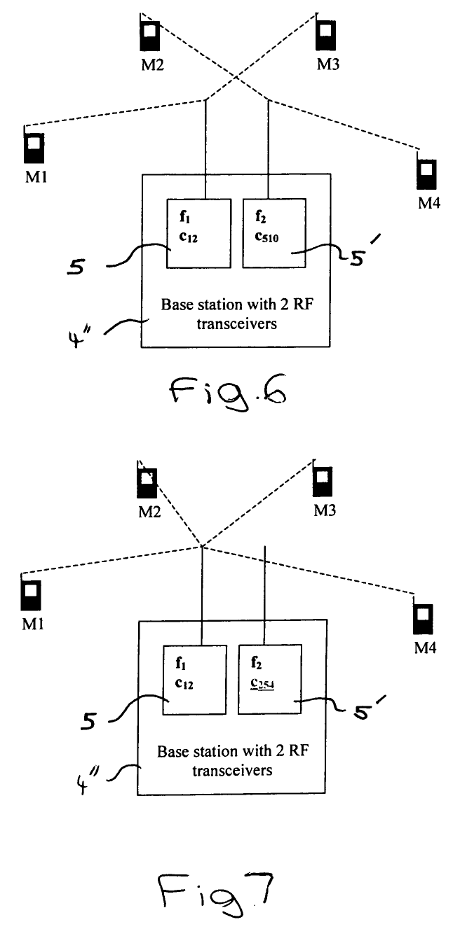

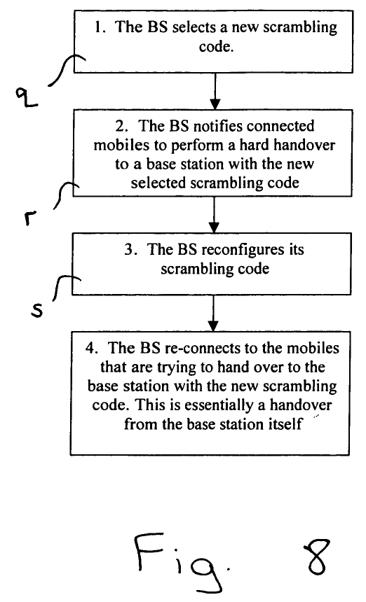

In some systems, base stations are able to select between multiple frequencies and/or access technology standards, for example IEEE 802.11 (which relates to wireless local area networks), IEEE 802.16 (which relates to wireless metropolitan area networks), Global System of Mobiles (GSM), and UMTS. Such a base station has multiple radio interfaces, each using different one frequency band and/or access technology. They can transfer connections with mobile users from one radio interface to another so as to free up a radio interface without dropping calls. A new scrambling code is assigned to the freed-up radio interface, which is then re-booted so as to use the new scrambling code. Call connections are then handed over to the re-booted radio interface. A simple example of this process is shown in FIGS. 6 and 7.

As shown in FIG. 6, a base station 4″ is shown with two radio interfaces 5, 5′. The radio interfaces 5,5′ are radio frequency transmitter-receivers. Initially two mobile terminals denoted M1 and M3 are connected to a radio interface 5 using a first frequency band f1 and scrambling code denoted c12. Also, initially two mobile terminals denoted M2 and M4 are connected to a second radio interface 5′ using a second frequency band f2 and a second scrambling code denoted c510.

As shown in FIG. 7, to change the scrambling code used by second radio interface 5′, all call connections are handed over to first interface 5. The second interface 5′ is then reprogrammed to use a new scrambling code denoted c254. The connections with mobile terminals that were handed over to the first interface 5 are then handed back (not shown) to the second interface 5′.

In some systems, a base station can change to using a new scrambling code without re-booting. As shown in FIG. 8, the base station selects a new scrambling code (step q). The base station then initiates handover (step r) of all connections to mobile terminals to a base station with the newly selected scrambling code. The base station then rapidly switches (step s) to using the new scrambling code. The connections with mobile terminals are then handed-over back to the base station (step t) because of the base station appearing to the mobile terminals as a different base station in view of it using the new scrambling code. This can be considered essentially a handover of connections with mobile terminals from a base station to itself reconfigured to use a new scrambling code.

The present invention may be embodied in other specific forms without departing from its essential characteristics. The described embodiments are to be considered in all respects only as illustrative and not restrictive. The scope of the invention is, therefore, indicated by the appended claims rather than by the foregoing description. All changes that come within the meaning and range of equivalency of the claims are to be embraced within their scope.

1. A method of a base station for wireless telecommunications changing scrambling code to be applied to pilot signals for transmission, the method comprising automatically:
identifying a need to change scrambling code,
selecting a new scrambling code for use,
reprogramming the base station to use the new scrambling code, and
using the new scrambling code for subsequent pilot signal transmissions.

2. A method according to claim 1, wherein the need to change scrambling code is identified by interference level increasing above a predetermined threshold.

3. A method according to claim 1, wherein the need to change scrambling code is identified by signal to interference ratio falling below a predetermined threshold.

4. A method according to claim 1, wherein the need to change scrambling code is identified by the number of unsuccessful handover attempts per unit time increasing above a predetermined value.

5. A method according to claim 1, wherein the base station has neighbouring base stations and stores a list of scrambling codes known to be assigned for use by the neighbouring base stations,
and the selecting of a new scrambling code for use comprises removing those known to be assigned for use from a full list of possible scrambling codes then selecting randomly from amongst the list of possible scrambling codes that remain.

6. A method according to claim 1, wherein the selecting of a new scrambling code for use comprises selecting randomly from amongst a full list of possible scrambling codes.

7. A method according to claim 1, wherein the reprogramming of the base station to use the new scrambling code comprises:
handing over connections with mobile terminals to neighbouring base stations,
being reprogrammed with the new scrambling code,
then being handed back those connections from the neighbouring base stations,
those connections thereafter making use of the new scrambling code.

8. A method according to claim 1, wherein the base station handing over the connections with mobile terminals to neighbouring base stations includes the base station reducing over time power of pilot signals; and the base station being handed back those connections includes the base station increasing over time power of pilot signals.

9. A method according to claim 7, in which the base station and neighbouring base stations comprise a self-deploying network wherein upon the base station handing over the connections with mobile terminals to neighbouring base stations, at least one of the neighbouring base stations automatically changes position.

10. A method according to claim 1, wherein the base station has multiple radios using different frequency bands and/or access technology standards, and reprogramming of the base station to use the new scrambling code comprises:
one of the radios handing over connections with mobile terminals to at least other of the radios within the base station,
said one of the radios being reprogrammed with the new scrambling code,
said one of the radios then being handed back those connections from said at least one other of the radios,
those connections thereafter making use of use the new scrambling code.

11. A method according to claim 1, wherein the reprogramming of the base station to use the new scrambling code comprises:
the base station initiating handing over of connections with mobile terminals to a base station having the new scrambling code,
the base station changing its scrambling code to the new scrambling code
the base station having the new scrambling code and so being handed over those connections,
those connections thereafter making use of use the new scrambling code.

12. A wireless telecommunications base station,
the base station comprising means to automatically change scrambling code to be applied to pilot signals for transmission, the means comprising:
a first processor operative to identify a need to change scrambling code,
a selector of a new scrambling code for use,
a second processor operative to reconfigure the base station to use the scrambling code for subsequent pilot signal transmissions.
